(19) United States
(12) Patent Application Publication
(10) Pub. No.: US 2014/0161341 A1
(43) Pub. Date: Jun. 12, 2014

(54) IMAGE REPRODUCING SYSTEM AND IMAGE FILE GENERATING APPARATUS

(71) Applicant: FUJIFILM Corporation, Tokyo (JP)

(72) Inventors: Yasunori OHTA, Ashigarakami-gun (JP); Yasuko YAHIRO, Ashigarakami-gun (JP); Takao KUWABARA, Ashigarakami-gun (JP); Akira HASEGAWA, San Jose, CA (US)

(73) Assignee: FUJIFILM Corporation, Tokyo (JP)

(21) Appl. No.: 14/177,738

(22) Filed: Feb. 11, 2014

Related U.S. Application Data
(63) Continuation of application No. PCT/JP2012/005010, filed on Aug. 7, 2012.
(60) Provisional application No. 61/523,017, filed on Aug. 12, 2011.

(51) Int. Cl. G06T 7/00

(52) U.S. Cl. CPC G06T 7/0012
USPC 382/132

(57) ABSTRACT

With respect to two images of an image for a right eye and an image for a left eye constituting a stereoscopic image, and which have been obtained at a mammography apparatus, a computer sets one of the two images, as a main image, and the remaining image as a sub-image. Further, a password releasable exclusively by an image reproducing terminal that copes with reproduction of a stereoscopic image file is set for the sub-image, and the two images are stored in a stereoscopic image file.

### BACKGROUND OF THE INVENTION

1. Field of the Invention

The present invention relates to an image file generating apparatus that sets, with respect to at least two images of an image for a right eye and an image for a left eye constituting a stereoscopic image, one of the at least two images as a main image and the remaining image or images as a sub-image or sub-images, and stores the at least two images in a stereoscopic image file, and to an image reproducing system including the image file generating apparatus.

2. Description of the Related Art

Conventionally, stereoscopic view utilizing parallax by displaying two images of an image for a right eye and an image for a left eye in combination was known. Such a stereoscopically viewable image (hereinafter, referred to as a stereoscopic image or a stereo image) is generated based on plural images obtained by performing imaging on the same subject from different positions, and which have parallax between them.

Generation of such a stereoscopic image is adopted not only in the fields of digital cameras and televisions, but also in the fields of radiography. Specifically, radiation is output to a patient from different directions from each other. Each radiation that has passed through the patient is detected by a radiographic image detector, and plural radiographic images having parallax between them are obtained. A stereoscopic image is generated based on the radiographic images. It is possible to observe a radiographic image with a sense of depth by generating the stereoscopic image in this manner, and to observe a radiographic image that is more appropriate for diagnosis (please refer, for example, to Japanese Unexamined Patent Publication No. 2010-110571 (Patent Document 1)).

### SUMMARY OF THE INVENTION

Even if plural radiographic images with parallax between them are obtained in radiography as described above, and a stereoscopic image becomes producible based on the radiographic images, radiologists who read images do not always want to observe just the stereoscopic image. In some cases, the radiologists want to display only one of the plural radiographic images constituting the stereoscopic image to observe the image, as an ordinary image (two-dimensional image). In such a case, if a different image of the plural radiographic images constituting the stereoscopic image is displayed each time, as an image for two-dimensional observation, there is a risk that correct diagnosis becomes impossible. Therefore, it is necessary that the same image is always displayed.

Meanwhile, it is desirable that data of plural radiographic images for constituting a stereoscopic image, and which have parallax between them, are stored and managed together in a stereoscopic image file by setting, as a main image, the most appropriate image for two-dimensional observation, and by setting, as a sub-image or sub-images, the remaining image or images. In this case, when a radiologist who reads images requests display of only one of the plural radiographic images constituting the stereoscopic image to observe the image as an ordinary image (two-dimensional image), if the main image is always displayed at an image reproducing apparatus that can cope with the stereoscopic image file, a different image is not displayed in each diagnosis. Diagnosis based on the most appropriate image is always possible. Therefore, appropriate diagnosis becomes possible.

However, even if storage and management is performed in such a file format, if radiographic images in the stereoscopic image file are freely referred to by an image reproducing apparatus that does not cope with the stereoscopic image file, erroneous diagnosis may be caused as described above, and that is not desirable.

In view of the foregoing circumstances, it is an object of the present invention to provide an image reproducing system in which radiographic images (sub-images) in a stereoscopic image file are not freely referable at an image reproducing apparatus that does not cope with the stereoscopic image file, and an image file generating apparatus.

An image reproducing system of the present invention includes an image file generating apparatus that sets, with respect to at least two images of an image for a right eye and an image for a left eye constituting a stereoscopic image, one of the at least two images as a main image and the remaining image or images as a sub-image or sub-images, and stores the at least two images in a stereoscopic image file, and an image reproducing device that copes with reproduction of the stereoscopic image file. The sub-image or sub-images are reproducible exclusively by the image reproducing device that copes with reproduction of the stereoscopic image file.

Here, the expression “an image reproducing device that copes with reproduction of the stereoscopic image file” means a device that can identify a main image or a sub-image about plural images in the stereoscopic image file. When a user tries to display only one of plural radiographic images in the stereoscopic image file to observe the image as an ordinary image (two-dimensional image), the main image is ordinarily displayed, as the two-dimensional image. However, when a user requests display of a sub-image, the sub-image may be displayed as a two-dimensional image while clearly indicating to the user that the image is a sub-image.

In the image reproducing system of the present invention, the image file generating apparatus may encrypt the sub-image or sub-images in a predetermined format, and store them in a stereoscopic image file. The image reproducing device may be a device that can decrypt the sub-image or sub-images encrypted in the predetermined format. Here, the term “encrypt” means processing for preventing display of an image unless a predetermined procedure is performed. The processing includes image compression processing besides general encrypting processing.

The image file generating apparatus may store the sub-image or sub-images in the stereoscopic image file by setting a password to be required to display the sub-image or sub-images. The image reproducing device may be a device that can input the password. Here, input of a password at the image reproducing device may be performed by providing the image reproducing device with a means for inputting a password by a user. Alternatively, when the image reproducing device displays the sub-image or sub-images, a password may be automatically input, and the sub-image or sub-images may be displayed.

The image file generating apparatus may set, as the main image, an image with a smallest imaging angle when imaging angles of the images in the stereoscopic image file for a subject are different from each other.

The image file generating apparatus may set, as the main image, an image with a highest image quality when image qualities of the images in the stereoscopic image file are different from each other.

The image file generating apparatus of the present invention sets, with respect to at least two images of an image for a right eye and an image for a left eye constituting a stereoscopic image, one of the at least two images as a main image and the remaining image or images as a sub-image or sub-images, and stores the at least two images in a stereoscopic image file.

The image file generating apparatus of the present invention may encrypt the sub-image or sub-images in a predetermined format, and store the sub-image or sub-images in the stereoscopic image file. Here, the term “encrypt” means processing for preventing display of an image unless a predetermined procedure is performed. The processing includes image compression processing besides general encrypting processing.

Further, the sub-image or sub-images may be stored in the stereoscopic image file by setting a password to be required to display the sub-image or sub-images.

Further, an image with a smallest imaging angle may be set, as the main image, when imaging angles of the images in the stereoscopic image file for a subject are different from each other.

Further, an image with a highest image quality may be set, as the main image, when image qualities of the images in the stereoscopic image file are different from each other.

According to the image reproducing system of the present invention, the image file generating apparatus that sets, with respect to at least two images of an image for a right eye and an image for a left eye constituting a stereoscopic image, one of the at least two images as a main image and the remaining image or images as a sub-image or sub-images, and stores the at least two images in a stereoscopic image file, and the image reproducing device that copes with reproduction of the stereoscopic image file are provided. Further, the sub-image or sub-images are reproducible exclusively by the image reproducing device that copes with reproduction of the stereoscopic image file. Further, when a user tries to display only one of plural radiographic images in the stereoscopic image file to observe the image, as an ordinary image (two-dimensional image), the image reproducing device that copes with reproduction of the stereoscopic image file can recognize and display the main image appropriate for two-dimensional observation. Further, it is possible to make an image reproducing device that does not cope with reproduction of the stereoscopic image file display only the main image that is appropriate for two-dimensional observation. Therefore, diagnosis is possible by displaying an appropriate image at any kind of image reproducing device.

According to the image file generating apparatus of the present invention, with respect to at least two images of an image for a right eye and an image for a left eye constituting a stereoscopic image, one of the at least two images is set as a main image and the remaining image or images are set as a sub-image or sub-images, and the at least two images are stored in a stereoscopic image file. Therefore, it is possible to generate a stereoscopic image file that makes it possible to display an appropriate image at any kind of image reproducing device when two-dimensional observation is performed.

### BRIEF DESCRIPTION OF THE DRAWINGS

FIG. 1 is a schematic diagram illustrating the configuration of a stereoscopic image imaging and display system for breasts using an image reproducing system according to an embodiment of the present invention;

FIG. 2 is a diagram illustrating an arm unit of the stereoscopic image imaging and display system for breasts illustrated in FIG. 1, and which is viewed from the right side of FIG. 1;

FIG. 3 is a schematic block diagram illustrating the configuration of the inside of a computer of the stereoscopic image imaging and display system for breasts illustrated in FIG. 1; and

FIG. 4 is a diagram illustrating the structure of a stereoscopic image file used in the stereoscopic image imaging and display system for breasts.

### DESCRIPTION OF THE PREFERRED EMBODIMENTS

Next, a schematic diagram illustrating the configuration of a stereoscopic image imaging and display system for breasts using an image reproducing system according to an embodiment of the present invention will be described with reference to drawings.

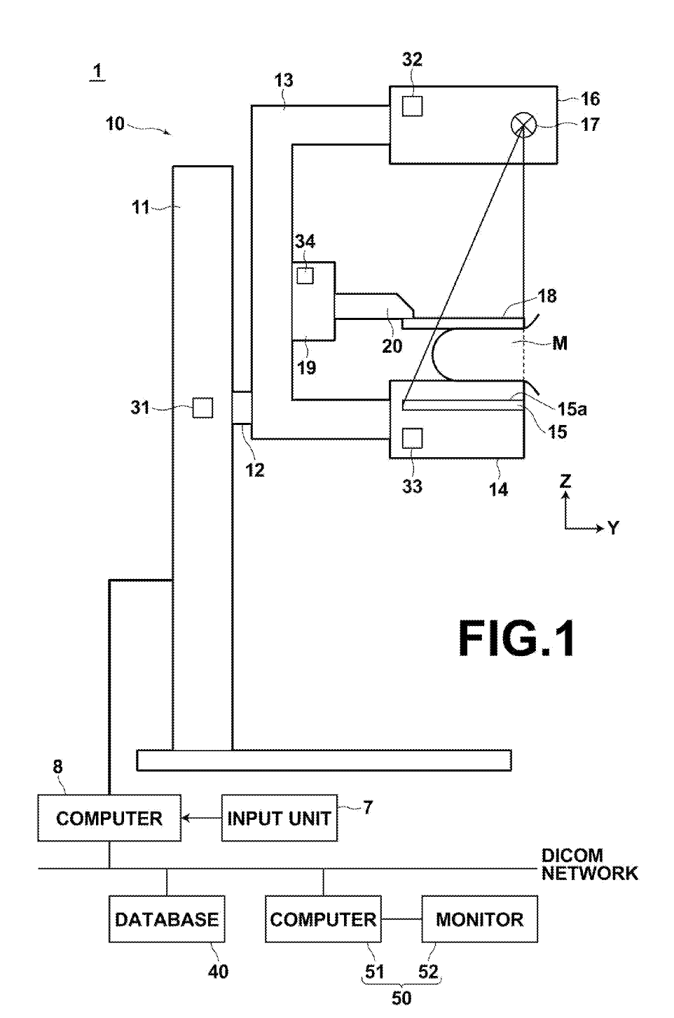

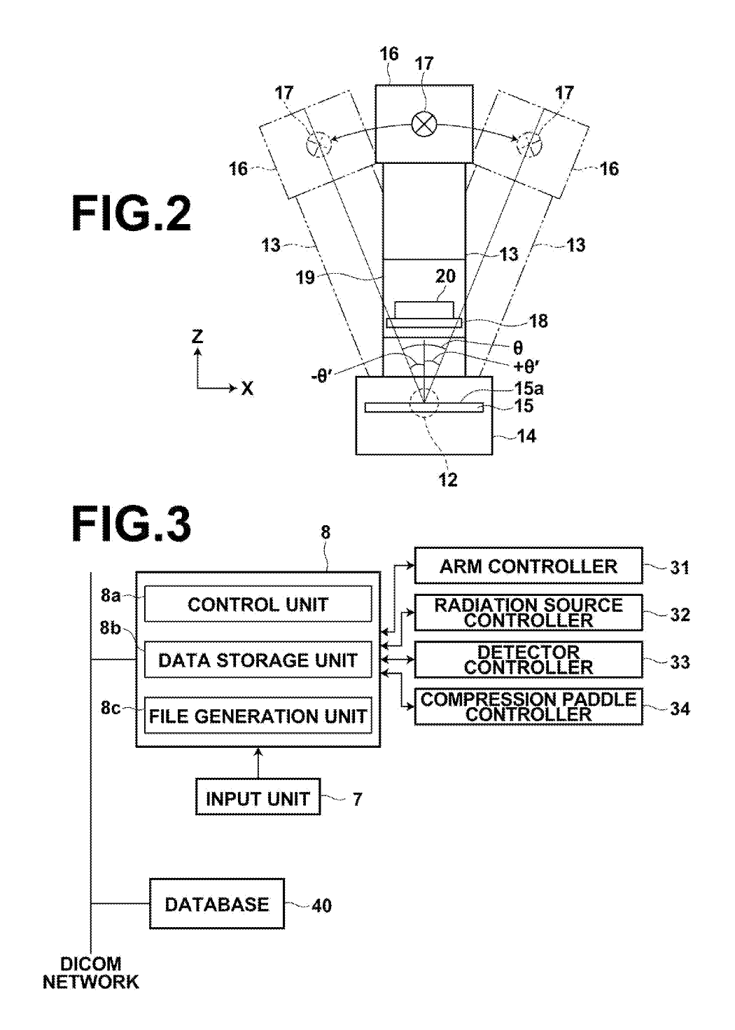

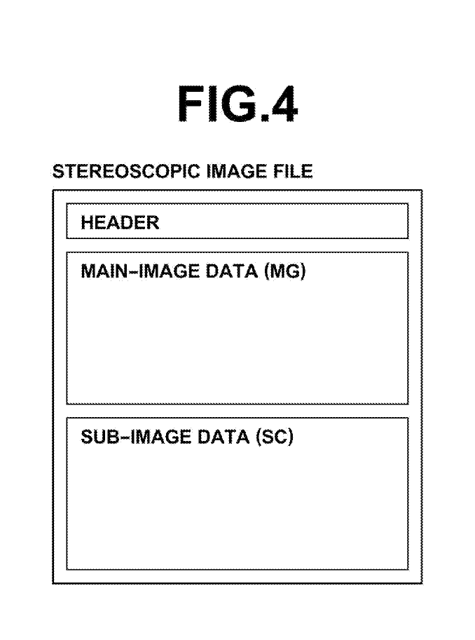

First, the schematic configuration of the whole stereoscopic image imaging and display system for breasts according to an embodiment of the present invention will be described. FIG. 1 is a schematic diagram illustrating the configuration of a stereoscopic image imaging and display system for breasts using an image reproducing apparatus according to an embodiment of the present invention. FIG. 2 is a diagram illustrating an arm unit of the stereoscopic image imaging and display system for breasts illustrated in FIG. 1, and which is viewed from the right side of FIG. 1. FIG. 3 is a schematic block diagram illustrating the configuration of the inside of a computer of the stereoscopic image imaging and display system for breasts illustrated in FIG. 1. FIG. 4 is a diagram illustrating the structure of a stereoscopic image file used in the stereoscopic image imaging and display system for breasts.

As illustrated in FIG. 1, a stereoscopic image imaging and display system 1 for breasts according to an embodiment of the present invention includes a mammography apparatus 10, a database 40 for storing and managing stereoscopic image files obtained at the mammography apparatus 10, and an image reproducing terminal 50 for reproducing a stereoscopic image file stored in the database 40. These elements are connected to DICOM (Digital Imaging and Communication in Medicine) network. The mammography apparatus 10 is connected to the DICOM network through a computer 8 for controlling the mammography apparatus 10.

First, the mammography apparatus 10 includes a base 11, a rotation shaft 12, and an arm unit 13, as illustrated in FIG. 1. The rotation shaft 12 is movable in a vertical direction (Z direction) with respect to the base 11, and rotatable. The arm unit 13 is connected to the base 11 by the rotation shaft 12. FIG. 2 illustrates the arm unit 13 viewed from the right side of FIG. 1.

The arm unit 13 is alphabet-C-shaped. An imaging table 14 is attached to an end of the arm unit 13, and a radiation output unit 16 is attached to the other end of the arm unit 13 in such a manner to face the imaging table 14. The rotation and the vertical movement of the arm unit 13 are controlled by an arm controller 31 mounted in the base 11.

A radiographic image detector 15, such as a flat panel detector, and a detector controller 33 are provided in the imaging table 14. The detector controller 33 controls readout of electric charge signals from the radiographic image detector 15. Further, a circuit board on which a charge amplifier, a correlated double sampling circuit, an AD conversion unit and the like are provided is also set in the imaging table 14. The charge amplifier converts electric charge signals read out from the radiographic image detector 15 into voltage signals. The correlated double sampling circuit performs sampling on the voltage signals output from the charge amplifier. The AD conversion unit converts the voltage signals into digital signals.

The imaging table 14 is structured in such a manner to be rotatable with respect to the arm unit 13. Even when the arm unit 13 rotates with respect to the base 11, it is possible to make the direction of the imaging table 14 remain constant relative to the base 11.

The radiographic image detector 15 can repeat recording and readout of radiographic images. The radiographic image detector 15 may be a so-called direct-type radiographic image detector, which generates electric charges by direct irradiation with radiation. Alternatively, the radiographic image detector 15 may be a so-called indirect-type radiographic image detector, which temporarily converts radiation into visible light and converts the visible light into electric charges. As a method for reading out radiographic image signals, it is desirable to use a so-called TFT readout method or a so-called light readout method. In the TFT readout method, radiographic image signals are read out by ON/OFF of a TFT (thin film transistor) switch. In the light readout method, radiographic image signals are read out by irradiation with readout light. The method for reading out radiographic image signals is not limited to these methods, and other methods may be used.

A radiation source 17 and a radiation source controller 32 are housed in the radiation output unit 16. The radiation source controller 32 controls timing of outputting radiation from the radiation source 17 and radiation generation conditions (tube electric current, tube voltage, time, and the like) at the radiation source 17.

Further, a compression paddle 18, a support unit 20 and a movement mechanism 19 are provided at a central part of the arm unit 13. The compression paddle 18 is arranged over the imaging table 14, and compresses breast M by pressing. The support unit 20 supports the compression paddle 18, and the movement mechanism 19 moves the support unit 20 in a vertical direction (Z direction). The position of the compression paddle 18 and compression pressure are controlled by a compression paddle controller 34.

The computer 8 includes a central processing unit (CPU), a storage device, such as a semiconductor memory, a hard disk and an SSD, and the like. These kinds of hardware constitute a control unit 8a, a data storage unit 8b and a file generation unit 8c, as illustrated in FIG. 3. The control unit 8a controls the whole system by outputting predetermined control signals to various controllers 31 through 34. A specific control method will be described later in detail. The data storage unit 8b stores radiographic image data obtained by the radiographic image detector 15 at each imaging angle, and the like. The file generation unit 8c stores, in a stereoscopic image file, plural images constituting a stereoscopic image obtained by the radiographic image detector 15. This stereoscopic image file will be described later in detail. In other words, the computer 8 has also a function as the image file generating apparatus in the embodiment of the present invention.

An input unit 7 connected to the computer 8 includes, for example, a keyboard or a pointing device, such as a mouse. The input unit 7 receives an input of imaging conditions, operation instructions and the like.

Next, the database 40 stores and manages various image files obtained at an imaging apparatus, such as the mammography apparatus 10, connected to the DICOM network in a centralized manner. The database 40 includes a storage device, such as a hard disk drive (HDD) and a solid state drive (SSD).

Next, the image reproducing terminal 50 is a terminal for reproducing various image files stored in the database 40. The image reproducing terminal 50 includes a computer 51 and a monitor 52.

The computer 51 can reproduce a stereoscopic image file generated by the file generation unit 8c. The hardware configuration of the computer 51 is similar to that of a general computer. A procedure for reproducing a stereoscopic image file will be described later in detail.

The monitor 52 is structured to display a stereo image (stereoscopic image) in such a manner that the stereo image is stereoscopically observable by displaying, as a two-dimensional image, a radiographic image for each imaging direction by using two radiographic image signals output from the computer 8.

As the structure for displaying the stereo image, for example, two display screens may be used, and radiographic images based on two radiographic image signals may be displayed in the two display screens, respectively. Further, a half mirror, a polarization glass or the like may be used to make one of the radiographic images enter the right eye of an observer, and to make the other radiographic image enter the left eye of the observer. The structure for displaying the stereo image in this manner may be adopted.

Alternatively, for example, two radiographic images may be overlapped with each other and displayed in such a manner to be shifted from each other by a predetermined parallax amount. Further, the two radiographic images may be observed by a polarization glass to generate a stereo image. Alternatively, as in a parallax barrier method or a lenticular method, two radiographic images may be displayed on a 3D liquid crystal, which enables stereopsis, to generate a stereo image.

Further, the monitor 52 may use only one radiographic image signal, and display an image as an ordinary two-dimensional image.

The structure is not limited to the structure of the monitor 52, which is used both to display a stereo image and to display a two-dimensional image, as described above. A device for displaying a stereo image and a device for displaying a two-dimensional image may be structured separately.

Next, the action of a stereoscopic image imaging and display system for breasts according to an embodiment of the present invention will be described.

First, operations during imaging will be described.

First, breast M is set on the imaging table 14, and breast M is compressed by a compression paddle 18 at predetermined pressure.

Next, an instruction for starting imaging is input at the input unit 7 after various imaging conditions including convergence angle θ for a stereo image are input.

Then, when an instruction for starting imaging is input at the input unit 7, imaging for a stereo image of breast M is performed. Specifically, first, information about actual imaging angles θ′ based on input conversion angle θ is output to the arm controller 31. In the embodiment of the present invention, it is assumed that θ=4° is set as information about convergence angle θ at this time, and that a combination of θ′=0° and θ′=4° is set as a combination of imaging angles θ′ constituting convergence angle θ. However, the angles are not limited to these angles, and a user who performs imaging may set arbitrary convergence angle θ at the input unit 7. Here, if convergence angle θ is too small or too large, appropriate stereopsis becomes difficult. Therefore, it is desirable that convergence angle θ is set at 4° or greater and 15° or less. It is desirable that one of the combination of imaging angles θ′, specifically, imaging angle θ′ for imaging a main image for two-dimensional observation is 0°. That is because an image obtained by imaging from the front side of the radiographic image detector 15 is most appropriate for two-dimensional observation.

As illustrated in FIG. 2, the arm controller 31 receives information about the first imaging angle θ′ output from the control unit 8a. The arm controller 31 outputs a control signal based on the information about the imaging angle θ′. The control signal controls the arm unit 13 so that imaging angle θ′ is inclined by 4° with respect to a direction perpendicular to a detection surface 15a.

The arm unit 13 rotates by 4° based on the control signal output from the arm controller 31. Then, the control unit 8a outputs control signals to the radiation source controller 32 and the detector controller 33 to make them output radiation and read out a radiographic image. Radiation is output from the radiation source 17 based on the control signal. Further, the radiation detector 15 detects a radiographic image obtained by imaging breast M from imaging angle θ′ of 4°. The detector controller 33 reads out radiographic image data, and the data storage unit 8b stores the radiographic image data.

Similarly, as illustrated in FIG. 2, the arm controller 31 receives information about the second imaging angle θ′ output from the control unit 8a. The arm controller 31 outputs a control signal based on the information about this imaging angle θ′. The control signal controls the arm unit 13 so that the arm unit 13 is perpendicular to the detection surface 15a (imaging angle θ′=0°.

The arm unit 13 rotates based on the control signal output from the arm controller 31 so that the arm unit 13 is perpendicular to the detection surface 15a. Then, the control unit 8a outputs control signals to the radiation source controller 32 and the detector controller 33 to make them output radiation and read out a radiographic image. Radiation is output from the radiation source 17 based on the control signal. Further, the radiation detector 15 detects a radiographic image obtained by imaging breast M from imaging angle θ′ of 0°. The detector controller 33 reads out radiographic image data, and the data storage unit 8b stores the radiographic image data.

One of the two radiographic images, which were obtained at imaging angle θ′ of 0° and at imaging angle θ′ of 4° as described above, is used as an image for the right eye and the other radiographic image is used as an image for the left eye.

When two sets of radiographic image data obtained at imaging angle θ′ of 0° and at imaging angle θ′ of 4° have been stored in the data storage unit 8b, the file generation unit 8c in the computer 8 sets, as main image (MG), radiographic image data obtained at imaging angle θ′ of 0°, and sets, as sub-image (SC), radiographic image data obtained at imaging angle θ′ of 4°, as illustrated in FIG. 4. Further, the file generation unit 8c adds a header including patient information and information, such as radiation dose during imaging, and generates and stores a stereoscopic image file of these data. At this time, a password that is known to image reproducing devices (terminals) coping with reproduction of stereoscopic image files is set for the sub-image. The sub-image is stored in such a manner that the sub-image is not displayable unless the password is released at an image reproducing device (terminal) coping with reproduction of stereoscopic image files when the sub-image is displayed.

The stereoscopic image file is stored in the data storage unit 8b. Further, the stereoscopic image file is sent to the database 40 connected to the DICOM network. The stereoscopic image file is stored and managed also in the database 40.

Next, operations during display of images will be described.

When a user requests stereo image display at an image reproducing terminal 50 coping with reproduction of the stereoscopic image file, the computer 51 of the image reproducing terminal 50 reads out the stereoscopic image file stored in the database 40, and outputs image signals of two images of the main image and the sub-image in this file to the monitor 52. A stereo image of breast M is displayed on the monitor 52. At this time, the password that has been set for the sub-image in the stereoscopic image file is automatically input and released at the computer 51.

When a user requests display of a two-dimensional image, the computer 51 of the image reproducing terminal 50 reads out the stereoscopic image file stored in the database 40, and automatically selects the main image in the file. Further, the computer 51 outputs an image signal of the main image to the monitor 52. A two-dimensional image of breast M is displayed on the monitor 52.

When an image reproducing device (terminal) does not cope with reproduction of a stereoscopic image file, it is impossible to release the password set for the sub-image. Therefore, if image data in the stereoscopic image file are tried to be displayed at an image reproducing device (terminal) that does not cope with reproduction of a stereoscopic image file, only the main image is displayable. It is impossible to display a stereo image by using image data of two images of the main image and the sub-image. Further, it is impossible to display just the sub-image, as a two-dimensional image.

Since the aforementioned structure is adopted, when a user tries to observe an ordinary image (two-dimensional image) by displaying only one of plural radiographic images in a stereoscopic image file, it is possible to make an image reproducing device (terminal) coping with reproduction of a stereoscopic image file recognize and display a main image, which is appropriate for two-dimensional observation. Further, it is possible to make an image reproduction device that does not cope with reproduction of a stereoscopic image file display only a main image, which is appropriate for two-dimensional observation. Therefore, diagnosis is possible while an appropriate image is displayed at any kind of image reproducing device (terminal).

In the aforementioned embodiment, when a stereoscopic image file is generated, a password that is known to the image reproducing terminal 50 coping with reproduction of the stereoscopic image file is set for a sub-image. Further, the image reproducing terminal 50 coping with reproduction of the stereoscopic image file automatically releases the password to display the sub-image. Alternatively, when a stereoscopic image file is generated, a sub-image may be stored after being encrypted by a cipher that is decryptable at the image reproducing terminal 50 coping with reproduction of the stereoscopic image file. Further, the image reproducing terminal 50 coping with reproduction of the stereoscopic image file may decrypt the encrypted sub-image when the sub-image is displayed.

Further, the embodiment is not limited to a mode in which an image obtained at the smallest imaging angle in the stereoscopic image file is set as the main image in the stereoscopic image file. An image with the highest image quality in the stereoscopic image file may be set as the main image.

Here, as a method for selecting an image with the highest image quality in the stereoscopic image file, an image with the highest S/N may be selected as the image with the highest image quality. Regarding a radiographic image, the phrase “with the highest S/N” specifically means that NEQ (Noise Equivalent Quanta: noise equivalent quanta) is high.

Besides the aforementioned method, an image with the highest sharpness may be selected as an image with a high image quality. Here, the term “high sharpness” means that attenuation of high frequency components in the image is small. Alternatively, an image with high resolution may be selected as an image with a high image quality.

The image with a high image quality may be selected by using other methods.

So far, desirable embodiments of the present invention have been described. The present invention is not limited to the stereoscopic image imaging and display system for breasts. The present invention may be combined with any kind of system, for example, such as a radiography apparatus for imaging the chest, the head or the like.

Further, besides the aforementioned embodiments, it is needless to say that various kinds of improvement and modification are possible without departing from the gist of the present invention.

What is claimed is:

1. An image reproducing system comprising:
an image file generating apparatus that sets, with respect to at least two images of an image for a right eye and an image for a left eye constituting a stereoscopic image, one of the at least two images as a main image and the remaining image or images as a sub-image or sub-images, and stores the at least two images in a stereoscopic image file; and
an image reproducing device that copes with reproduction of the stereoscopic image file,
wherein the sub-image or sub-images are reproducible exclusively by the image reproducing device.

2. The image reproducing system, as defined in claim 1, wherein the image file generating apparatus encrypts the sub-image or sub-images in a predetermined format, and stores the sub-image or sub-images in the stereoscopic image file, and
wherein the image reproducing device can decrypt the sub-image or sub-images that have been encrypted in the predetermined format.

3. The image reproducing system, as defined in claim 1, wherein the image file generating apparatus stores the sub-image or sub-images in the stereoscopic image file by setting a password to be required to display the sub-image or sub-images, and
wherein the image reproducing device can input the password.

4. The image reproducing system, as defined in claim 1, wherein the image file generating apparatus sets, as the main image, an image with a smallest imaging angle when imaging angles of the images in the stereoscopic image file for a subject are different from each other.

5. The image reproducing system, as defined in claim 2, wherein the image file generating apparatus sets, as the main image, an image with a smallest imaging angle when imaging angles of the images in the stereoscopic image file for a subject are different from each other.

6. The image reproducing system, as defined in claim 3, wherein the image file generating apparatus sets, as the main image, an image with a smallest imaging angle when imaging angles of the images in the stereoscopic image file for a subject are different from each other.

7. The image reproducing system, as defined in claim 1, wherein the image file generating apparatus sets, as the main image, an image with a highest image quality when image qualities of the images in the stereoscopic image file are different from each other.

8. The image reproducing system, as defined in claim 2, wherein the image file generating apparatus sets, as the main image, an image with a highest image quality when image qualities of the images in the stereoscopic image file are different from each other.

9. The image reproducing system, as defined in claim 3, wherein the image file generating apparatus sets, as the main image, an image with a highest image quality when image qualities of the images in the stereoscopic image file are different from each other.

10. An image file generating apparatus, wherein with respect to at least two images of an image for a right eye and an image for a left eye constituting a stereoscopic image, one of the at least two images is set as a main image and the remaining image or images are set as a sub-image or sub-images, and the at least two images are stored in a stereoscopic image file.

11. The image file generating apparatus, as defined in claim 10, wherein the sub-image or sub-images are encrypted in a predetermined format, and stored in the stereoscopic image file.

12. The image file generating apparatus, as defined in claim 10, wherein the sub-image or sub-images are stored in the stereoscopic image file by setting a password to be required to display the sub-image or sub-images.

13. The image file generating apparatus, as defined in claim 10, wherein an image with a smallest imaging angle is set, as the main image, when imaging angles of the images in the stereoscopic image file for a subject are different from each other.

14. The image file generating apparatus, as defined in claim 11, wherein an image with a smallest imaging angle is set, as the main image, when imaging angles of the images in the stereoscopic image file for a subject are different from each other.

15. The image file generating apparatus, as defined in claim 12, wherein an image with a smallest imaging angle is set, as the main image, when imaging angles of the images in the stereoscopic image file for a subject are different from each other.

16. The image file generating apparatus, as defined in claim 10, wherein an image with a highest image quality is set, as the main image, when image qualities of the images in the stereoscopic image file are different from each other.

17. The image file generating apparatus, as defined in claim 11, wherein an image with a highest image quality is set, as the main image, when image qualities of the images in the stereoscopic image file are different from each other.

18. The image file generating apparatus, as defined in claim 12, wherein an image with a highest image quality is set, as the main image, when image qualities of the images in the stereoscopic image file are different from each other.
